(19) United States
(12) Patent Application Publication
(10) Pub. No.: US 2006/0189782 A1
(43) Pub. Date: Aug. 24, 2006

(54) Elastomeric material

(76) Inventors: David D. Peters, Wyandotte, MI (US); Micheal C. May, Clawson, MI (US); Joe C. Wilson, Woodhaven, MI (US)

Correspondence Address: BASF AKTIENGESELLSCHAFT, CARL-BOSCH STRASSE 38, 67056 LUDWIGSHAFEN, LUDWIGSHAFEN, 69056, DE

(21) Appl. No.: 11/062,153

(22) Filed: Feb. 18, 2005

(51) Int. Cl. C08G 18/32; C08L 75/04; B32B 27/40

(52) U.S. Cl. 528/85; 528/44; 525/452

(57) ABSTRACT

An elastomeric material is disclosed comprising a resin composition and a polyisocyanate composition for reacting with the resin composition and forming cross-linkages to define a matrix and having a non-reactive diluent dispersed therein. The resin composition comprises a first polyol, a second polyol, and a surfactant. The first polyol has an actual functionality of from 2.0 to 7.0 and a hydroxyl number of from 100 to 600 mg KOH/g. The second polyol, different than the first polyol, has an actual functionality of from 3.5 to 5.0 and a hydroxyl number of greater than 650 mg KOH/g. The surfactant comprises the reaction product of a mono- or a poly-functional initiator, at least one hydrophilic component having a polyether chain of from 4 to 40 carbon atoms and having at least one isocyanate-reactive group, and at least one hydrophobic group having an alkyl chain of from 4 to 50 carbon atoms. The elastomeric material has a weight-average equivalent weight between the cross-linkages of from 75 to 250 g/mol.

### BACKGROUND OF THE INVENTION

1. Field of the Invention

The subject invention relates generally to an elastomeric material, and more particularly to an improved elastomeric material having a non-reactive diluent dispersed therein.

2. Description of the Related Art

Bowling balls can generally be constructed of a core with a coverstock surrounding the core. Additional layers may be present between the core and the coverstock to vary gyroscopic and rotational properties of the bowling ball. The core is generally a center weight within the bowling ball and may be formed of various materials. The coverstock is the outer shell of the bowling ball. There are different types of materials that may form the coverstock, such as, but not limited to, polyester and polyurethane compositions.

The type of coverstock is selected depending upon the desired bowling ball on-lane performance. For example, coverstocks formed of polyester are very durable, can have varied aesthetics and are sufficiently hard, but have low apparent friction on an oiled lane surface. This low friction causes the bowling ball to skid more and maintain a straighter trajectory when bowled, or rolled on the lane, i.e., less hook is achieved. Polyurethane coverstocks, on the other hand, can afford similar properties or be modified making them softer and having higher on-lane friction. These polyurethane coverstocks are known as reactive. The higher friction causes the bowling ball to hook more and to skid less when rolled. Additional additives may be added to the polyurethane coverstock to provide different levels of friction and hardness, such as resin, ceramic, or glass particles.

High performance polyurethane elastomeric materials have been used for reactive bowling ball coverstocks for many years. Polyurethane elastomeric materials are used industry-wide for professional bowling balls (and high-end amateur products) because they provide the necessary on-lane performance required at this higher level of play.

In the game of bowling, a skillful bowler generally rolls a ball down a bowling lane, or alley, such that the bowling ball enters the pin placement at an angle with respect to longitudinal axis of the head pin. It is generally known that the larger the angle through which the bowling ball travels before it hits the pins, the higher the probability of impact the pins at the preferred angle, thereby resulting in a higher percentage of strikes, knocking down all ten bowling pins with one throw of the bowling ball, or a larger number of pins being knocked down. Therefore, of particular importance is the ability of the ball to “hook” on the bowling lane. The bowling community calls this hooking behavior lane reaction and a ball that hooks well is known as a “reactive ball.” Bowling alleys or lanes are typically coated with oil to challenge bowlers of varying levels. When the bowling ball is rolled, it becomes coated with oil in the ball track that causes the bowling ball to skid, instead of roll, which causes the bowling ball to have less on-lane performance.

The elastomeric materials of the related art generally comprise the reaction product of a polyol and a polyisocyanate forming cross-linkages with the polyol and having a non-reactive diluent dispersed within the matrix. The non-reactive diluent is typically a plasticizer and is one of the most important elements contributing to ball reactivity. Plasticizers such as 2,2,4-trimethyl-1,3-pentanediol diisobutyrate (Kodaflex “TXIB”), from Eastman Chemical Company, are used in such polyurethane elastomeric materials. However, the plasticizer tends to soften the elastomeric material.

The TXIB also impacts the ability of the elastomeric material to absorb oil. During the exothermic reaction of the polyol and the polyisocyanate to form the elastomeric material, the TXIB expands creating voids within the matrix and then the TXIB contracts after the exothermic reaction, i.e., when cooled. The related art matrix has a tendency to collapse upon itself because the matrix does not have a sufficient strength to withstand this expansion. This collapse fills the voids created in the matrix and thereafter the elastomeric material does not quickly absorb oil.

Accordingly, the related art elastomeric materials are characterized by one or more inadequacy. Therefore, it would be advantageous to provide an elastomeric material having a non-reactive diluent dispersed therein, yet still having a sufficient hardness and improved oil adsorption.

### SUMMARY OF THE INVENTION AND ADVANTAGES

The subject invention provides an elastomeric material that comprises the reaction product of a resin composition and a polyisocyanate composition forming cross-linkages with the resin composition to define a matrix. A non-reactive diluent is dispersed within the matrix. The resin composition comprises A) a first polyol, B) a second polyol, and C) a surfactant. The first polyol has an actual functionality of from 2.0 to 7.0 and a hydroxyl number of from 100 to 600 mg KOH/g. The second polyol is different than the first polyol and has an actual functionality of from 3.5 to 5.0 and a hydroxyl number of greater than 650 mg KOH/g.

The surfactant comprises the reaction product of i) a mono- or a poly-functional initiator, ii) at least one hydrophilic component having a polyether chain of from 4 to 40 carbon atoms and having at least one isocyanate-reactive group, and iii) at least one hydrophobic group having an alkyl chain of from 4 to 50 carbon atoms. The elastomeric material has a weight-average equivalent weight between the cross-linkages of from 75 to 250 g/mol resulting from the reaction of the polyisocyanate composition and the resin composition.

Through experimentation, it has been surprisingly discovered that the unique combination of the first polyol, the second polyol, and the surfactant results in the matrix having a sufficient strength to withstand the expansion of the non-reactive diluent. Specifically, the weight-average equivalent weight is a primary indicator of the elastomeric materials ability to withstand the collapse that characterizes the related art. Since the matrix does not collapse or undergoes reduced collapsing, more voids are present within the matrix. When the elastomeric material is exposed to oil, the oil quickly adsorbs into the elastomeric material because of the presence of these voids.

The subject invention is also able to incorporate higher amounts of the non-reactive diluent into the matrix while still achieving a desired hardness and aesthetics, whereas the elastomeric material of the related art becomes too soft. The hardness of the subject invention is maintained because the matrix has increased strength and undergoes reduced collapse.

### DETAILED DESCRIPTION OF THE INVENTION

An improved elastomeric material is disclosed herein. The elastomeric material generally comprises the reaction product of a resin composition and a polyisocyanate composition that forms cross-linkages to define a matrix. The subject invention incorporates a non-reactive diluent that is dispersed within the matrix for improving various physical properties of the elastomeric material as will be described below in more detail. Those skilled in the art appreciate that elastomeric materials are generally formed with little or no added physical or chemical blowing agents. However, the components forming the elastomeric material may include small amounts of chemical blowing agents, such as water, that are present from the respective processing of these components.

Illustrative physical properties of the elastomeric material are intrinsic to the bowling ball application and include hardness and oil adsorption. The elastomeric material is required to have a Shore D hardness of at least 72 and should also be able to absorb oil within a desired amount of time, such as within thirty minutes. Various uses for such an elastomeric material having these physical properties are recognized by those skilled in the art. However, it is envisioned that the hardness, as well as oil adsorption and other physical properties could be adjusted to fit the requirements of other applications. Other uses include, but are not limited to, bumpers, rollers, flooring, table edging, molding/compounding materials, mannequins, and belting materials.

As one illustrative example, the elastomeric material may be utilized as a coverstock for a bowling ball. The type of coverstock is selected depending upon the desired on-lane reaction performance of the bowling ball when bowled. For example, high performance coverstocks formed of polyurethane coverstocks are generally at the lower end of the hardness scale and have higher friction. The higher friction causes the bowling ball to have stronger interaction with the lane surface which results in an increased hook.

Bowling alleys, or lanes, are coated with oil to challenge bowlers of varying levels and the pattern of the oil changes during the course of bowling. When the bowling ball is rolled, it tends to become coated in oil that causes the bowling ball to skid, instead of roll, which causes the bowling ball to have less on-lane performance. Therefore, it is desirable that the bowling ball is able to absorb oil to reduce the amount of skidding. If the bowling ball is unable to absorb the oil, then the bowling ball will have reduced friction, causing the bowling ball to skid and have a reduced hook potential.

Another important aspect of the coverstock is hardness. When the coverstock is harder, the bowling ball transfers more energy to pins. Therefore, it is desirable to provide the coverstock having a sufficient hardness of at least 72 Shore D. The American Bowling Congress (ABC) requires a hardness of at least 72 Shore D, whereas the Professional Bowlers Association (PBA) requires a hardness of at least 75 Shore D.

Typically, bowlers want aesthetically appealing bowling balls therefore, manufactures produce bowling balls having distinctive colors and color patterns. One method of accomplishing the distinctive appearance of the bowling balls is to add pigments and/or dyes to the coverstock to color the bowling ball. Certain coverstocks require more or less pigment to be added which can affect the physical properties described above. One indicator of the coverstocks ability to be colored is phase, which as understood by those skilled in the art, refers to the clarity of the un-pigmented coverstock. The phase can range from no light passing through the coverstock, which is referred to as high phase, to light easily passing through the coverstock, which is referred to as no phase. If the coverstock is cloudy, then the phase is between these two end points, referred to slight phase. When the coverstock has high phase, the coverstock is more difficult to color and may require larger amounts of coloring additives, which may undesirably impact the physical properties. It is desired that the coverstock have slight to no phase. Not intending to be limited to or bond by any particular theory, phasing is believed to be the result of the formation of isolated, non-compatible pockets of the non-reactive diluent. The pockets of non-reactive diluent is trapped in high concentrations within the polymer matrix effecting the refraction of light as it passes through or reflects off of the elastomeric material. Therefore, improving the compatibility of the diluent in the polymer matrix can reduce the observed phasing.

The resin composition generally comprises A) a first polyol, B) a second polyol, and C) a surfactant. The first polyol, the second polyol, and the surfactant are added in amounts sufficient to ensure that the resin composition has the following desired properties. The resin composition has a hydroxyl number of from 100 to 500 mg KOH/g, preferably from 200 to 400 mg KOH/g, and more preferably from 225 to 350 mg KOH/g. It is to be appreciated that hydroxyl number may include functional groups other than hydroxyl groups, such as, but not limited to, amine groups. The resin composition also has an equivalent weight of between 100 and 400, preferably from 150 to 300, and more preferably from 165 to 250. The equivalent weight is understood by those skilled in the art to represent a portion of the molecular weight of the resin composition that contains one functional group, such as one hydroxyl group.

In order to achieve these desired properties, the first polyol is present in an amount of from 5 to 25 parts by weight and the second polyol is present in an amount from 15 to 45 parts by weight, both based on 100 parts by weight of the resin composition. Preferably, the first polyol is present in an amount of from 5 to 20 parts by weight, and more preferably from 5 to 15 parts by weight, both based on 100 parts by weight of the resin composition. The second polyol is preferably present in an amount of from 20 to 40 parts by weight, and more preferably from 25 to 35 parts by weight, both based on 100 parts by weight of the resin composition. The surfactant is present in an amount of from 0.1 to 15 parts by weight, preferably from 1 to 10 parts by weight, and more preferably from 2 to 8 parts by weight, each based on 100 parts by weight of the resin composition.

The first polyol (A) has an actual functionality of from 2.0 to 7.0 and a hydroxyl number of from 100 to 600 mg KOH/g. Preferably, the first polyol is a hydroxyl-functional polyether polyol having an actual functionality of approximately 2.0 to 3.5. The terminology “actual functionality” is the functionality of the polyol after manufacture, whereas the terminology “theoretical functionality” is the functionality expected based upon the functionality of the initiator molecule, as understood by those skilled in the art. The first polyol is formed from a polyol initiator selected from trimethylolpropane, polyethylene glycol, polypropylene glycol, glycerin, and mixtures thereof.

Illustrative examples of the first polyol include, but are not limited, a polyethylene and propylene glycol initiated propylene oxide polyol having an actual functionality of approximately 3.53, which is commercially available as PEP-550 from BASF Corporation; a trimethylolpropane (TMP) initiated propylene oxide polyol having an actual functionality of approximately 2.96, which is commercially available as TP-740 from BASF Corporation; a glycerin initiated propylene oxide polyol having an actual functionality of approximately 2.99, which is commercially available as GP-730 from BASF Corporation; and a TMP initiated ethylene oxide polyol having an actual functionality of approximately 3, which is commercially available as P-1158 from BASF Corporation.

The second polyol (B) is different than the first polyol and has an actual functionality of from 3.5 to 5.0. Preferably, the second polyol is a hydroxyl-functional polyether polyol having an actual functionality of approximately 4. The second polyol preferably has a hydroxyl number of greater than 600 mg KOH/g and is formed from an amine-based initiator. More preferably, the amine-based initiator is ethylene diamine. One illustrative example of the second polyol includes, but is not limited to, an ethylene diamine initiated propylene oxide polyol having an actual functionality of approximately 4, which is commercially available as Quadrol from BASF Corporation.

The surfactant (C) comprises the reaction product of i) a mono- or a poly-functional initiator, ii) at least one hydrophilic component, and iii) at least one hydrophobic group. Preferably, the surfactant has a hydroxyl number of from 40 to 300 mg KOH/g, a hydrophilic/lipophilic balance (HLB) of greater than 6.5, and an acid value of from 2 to 8 mg KOH/g. It is preferred that the surfactant comprises ester linkages that bond the hydrophobic groups to at least one of the initiator and the hydrophilic component. More preferably, the surfactant has a hydroxyl number of from 50 to 250 mg KOH/g, a hydrophilic/lipophilic balance (HLB) of greater than 8 and most preferred the surfactant has a hydroxyl number of from 65 to 200 mg KOH/g, a hydrophilic/lipophilic balance (HLB) of greater than or equal to 9.

The mono-functional initiator is preferably an aromatic hydrocarbon having hydroxyl groups bonded thereto. An illustrative example of such a mono-functional initiator includes, but is not limited to, phenol. The poly-functional initiator may be selected from diols, triols, tetrols and higher functionality alcohols, amines, and mixtures thereof. The diol may be selected from polyethylene glycol, polypropylene glycol, polybutylene glycol, and mixtures thereof and preferably has a theoretical functionality of from 0.5 to 2. The triol may be selected from glycerin, trimethylolethane, trimethylolpropane, and mixtures thereof and preferably has a theoretical functionality of from 0.5 to 3. More preferably, the poly-functional initiator comprises glycerin. The terminology “theoretical functionality” refers to the entire initiator such that one moiety has a functionality of three, while another moiety has a functionality of two, such that the initiator has a theoretical functionality of 2.5.

The tetrol or higher may be selected from erythritol, pentaerythritol, dipentaerythritol, dulcitol, threitol, and mixtures thereof. The amine may be selected from alkanolamines, ethylene diamines, diethylene triamines, and mixtures thereof.

The hydrophilic component (ii) is preferably a polyether chain of from 4 to 40 carbon atoms and has at least one isocyanate-reactive group. Those skilled in the art recognize that the polyether chain may comprise ethylene oxide, propylene oxide, butylene oxide, and mixtures thereof. More preferably, the polyether chain comprises ethylene oxide and the ethylene oxide is present in an amount of from 5 to 25 moles per mole of initiator.

The hydrophobic group (iii) has an alkyl chain of from 4 to 50 carbon atoms and is preferably a fatty acid ester. Said another way, the alkyl chain is preferably a fatty acid having from 4 to 50 atoms that is reacted with the initiator or the hydrophilic component to form the corresponding ester. The hydrophobic group may also be referred to as a lipophilic group as understood by those skilled in the art.

The fatty acid may be selected from caproic, caprylic, capric, lauric, myristic, palmitic, stearic, isostearic, isopalmitic, arachic, behenic, cerotic, and melissic acids. In addition, polycarboxylic acids or hydroxycarboxylic acids may be added for oligomerization. Examples include oxalic acid, malonic acid, succinic acid, maleic acid, fumaric acid, glutaric acid, adipic acid, suberic acid, sebacic acid, 1,11-undecanedioic acid, 1,12-dodecanedioic acid, phthalic acid, isophthalic acid, terephthalic acid, hexahydrophthalic acid, tetrahydrophthalic acid or dimer fatty acid, trimer fatty acid, citric acid, lactic acid, tartaric acid, ricinoleic acid, 12-hydroxystearic acid.

The fatty acid ester is preferably selected from butanates, hexanates, octanoates, decanoates, laureates, stearates, palmitates, and mixtures thereof. Additional examples of preferred fatty acid esters include the natural fats and oils of rape, sunflower, soya, linseed, castor beans, coconuts, oil palms, and mixtures thereof.

An illustrative example of the surfactant includes, but is not limited to, ICONOL® NP-6, commercially available from BASF Corporation, having the mono-functional initiator as phenol, the hydrophobic group is an alkyl chain of nine carbons bonded to the phenol, which is also known as nonylphenol. The nonylphenol is then ethoxylated with six moles of ethylene oxide to form the hydrophilic component.

Other examples include, but are not limited to, MAPEG® 200 ML, commercially available from BASF Corporation, having the poly-functional initiator and the hydrophilic component as polyethylene glycol, and the hydrophobic group is an alkyl chain of lauric acid; MAZOL® 159, commercially available from BASF Corporation, comprising a mixture of ethoxylated monoglyceryl cocoate containing an average of 7 moles of ethylene oxide per reactive hydroxyl group, a hydroxyl number of about 194 mg KOH/gram, and an actual functionality of about 2; MAZOL® 80 MGK, commercially available from BASF Corporation, including an ethoxylated monodiglyceride which is comprised of a substituted glyceride containing an alkyl chain of 14 to 18 carbons and capped with about 12 moles of ethylene oxide per reactive end group and a hydroxyl number of about 72 mg KOH/gram and an actual functionality of about 1.5.

The polyisocyanate composition forms the cross-linkages with the resin composition to define the matrix. The polyisocyanate composition may include organic polyisocyanates, modified isocyanates, isocyanate-terminated prepolymers, and mixtures thereof. The polyisocyanate composition may include aliphatic, alicyclic, and aromatic polyisocyanates characterized by containing two or more isocyanate groups. Mixtures of polyisocyanates may also be used, which include crude mixtures of di- and higher functionality polyisocyanates.

Additional illustrative examples of the polyisocyanate which may be employed are, but not limited to, toluene-2,4- and 2,6-diisocyanates (TDI) or mixtures thereof; diphenylmethane-4,4′-diisocyanate and diphenylmethane-2,4′-diisocyanate (MDI) or mixtures thereof, the mixtures preferably containing about 10 parts by weight 2,4′-MDI or higher; polymethylene polyphenyl isocyanates; naphthalene-1,5-diisocyanate; 3,3′-dimethyl diphenylmethane-4,4′-diisocyanate; triphenyl-methane triisocyanate; hexamethylene diisocyanate; 3,3′-ditolylene-4,4-diisocyanate; butylene 1,4-diisocyanate; octylene-1,8-diisocyanate; 4-chloro-1,3-phenylene diisocyanate; 1,4-, 1,3-, and 1,2-cyclohexylene diisocyanates and; in general, the polyisocyanates disclosed in U.S. Pat. No. 3,577,358, the disclosure of which is incorporated herein by reference. Preferred polyisocyanates include 2,4′-MDI, 4,4′-MDI, 2,2′-MDI, polymeric MDI, and mixtures thereof.

The organic polyisocyanate may comprise an isocyanate-terminated prepolymer. The isocyanate-terminated prepolymer may be prepared by reacting an excess of a polyisocyanate with a polyol which, on a polyisocyanate to polyol basis, may range from about 20:1 to 2:1. The polyols include, for example, polyethylene glycol, polypropylene glycol, diethylene glycol monobutyl ether, ethylene glycol monoethyl ether, triethylene glycol, and the like. The polyols may also include glycols or polyglycols partially esterified with carboxylic acids including all polyester polyols and all polyether polyalkylene polyols. Such polyols are well known in the art and will not be further described. The modified isocyanates may include carbodiimides, allophanates, isocyanurates, and biurets.

The elastomeric material has a weight-average equivalent weight between the cross-linkages of from 75 to 250 g/mol resulting from the reaction of the polyisocyanate composition and the resin composition. Said another way, once the elastomeric material has been formed, the weight-average equivalent weight is the total molecular weight of the elastomeric material divided by the number of cross-linkages per mole of elastomeric material. The weight-average equivalent weight includes the molecular weight of both the resin composition and the isocyanate composition. Preferably, the weight-average equivalent weight is from 100 to 200 g/mol, and more preferably from 100 to 150 g/mol.

The elastomeric material also has a cross-link functionality from 2 to 5 cross-linkages per unit mass of the elastomeric material based upon the reaction of the polyisocyanate composition and the resin composition. Preferably, the cross-link functionality is from 2.5 to 3.5, and more preferably form 2.75 to 3.5. Through experimentation, it has been discovered that both the weight-average equivalent weight and the cross-link functionality impact the strength of the matrix. The matrix has a tendency to collapse upon itself when the weight-average equivalent weight and the cross-link functionality are outside the desired ranges. As will be described below further, the strength of the matrix is important to provide the physical properties of the elastomeric material.

The elastomeric material may optionally a chain extender for reacting with the isocyanate composition for creating a more dynamic segregation of hard and soft segments within the matrix thus further improving the performance. The chain extender may be selected from aliphatic diols, triols, and mixtures thereof. Suitable examples of the chain extender include, but are not limited to, diethylene glycol (DEG) or dipropylene glycol (DPG). The chain extender may be present in an amount of from 0.1 to 10 parts by weight based on 100 parts by weight of the resin composition. It is to be appreciated by those skilled in the art that the chain extender may not be utilized, since the first and the second polyol act as suitable chain extenders.

The non-reactive diluent, as described above, is dispersed within the matrix. Preferably, the non-reactive diluent is a non-lubricating plasticizer and comprises 2,2,4-trimethyl-1,3-pentanediol diisobutyrate (TXIB). It is to be understood by those skilled in the art that other non-reactive diluents that are equivalent to 2,2,4-trimethyl-1,3-pentanediol diisobutyrate may also be used. The non-reactive diluent is present in an amount of from 30 to 70 parts by weight, preferably from 40 to 65 parts by weight, and more preferably from 43 to 60 parts by weight, each based on 100 parts by weight of the resin composition.

The non-reactive diluent softens the matrix to the desired hardness while also allowing for improved oil adsorption by, but not intending to be bond to or limited by any particular theory, modifying the polymer morphology via thermal expansion of the non-reactive diluent during the exothermic urethane reaction and polymer curing process. The non-reactive diluent is typically a liquid and has a low coefficient of thermal expansion. Formation of the elastomeric material results in an exothermic reaction that expands the non-reactive diluent. One problem encountered in the related art was that if too much non-reactive diluent was added, then elastomeric material can have an inadequate hardness, slower oil adsorption, and inferior aesthetics. However, it has surprisingly been discovered that higher amounts of the non-reactive diluent may be added in the subject invention while still achieving the desired hardness, improved oil adsorption, and the desired appearance of the polymeric material.

As was briefly discussed above, during the formation of the elastomeric material, the non-reactive diluent expands during the exothermic urethane reaction and then contracts as the material cools. This shrinking of the non-reactive diluent creates voids within the matrix. With the related art, the matrix was not sufficiently strong and the matrix collapses as the diluent contracts, effectively eliminating or filling the voids formed by the expansion. The matrix formed according to the subject invention, however, is sufficiently strong due to the level of cross-linking and the size of the polymer matrix to withstand excessive shrinkage and the voids are maintained. It is known to those skilled in that art, that limited shrinkage is very difficult to completely eliminate. Oil that contacts the elastomeric material of the subject invention can be quickly absorbed into these voids, whereas the related art would not absorb the oil as quickly, if at all.

The non-reactive diluent also impacts the phase, or clarity, of the elastomeric material. More specifically, it is believed that the more compatible the non-reactive diluent is in the matrix, the clearer and more transparent the cured elastomer material remains. This clarity is a benefit because it allows for improved finished aesthetics. Without intending to be bound to theory, it is believed that if the matrix collapses as in the related art, then the non-reactive diluent cannot be well dispersed resulting in a more highly phased material, as discussed above. These highly phased materials require more pigment that can further deteriorate the physical properties and increase costs of manufacturing. The subject invention has only slight phase allowing for easier pigmentation with less pigments. Since less pigments may be added, the elastomeric material will likely maintain the desired and improved physical properties.

The following examples, illustrating the formation of the elastomeric material according to the subject invention and illustrating certain properties of the elastomeric material, as presented herein, are intended to illustrate and not limit the invention.

### EXAMPLES

Various resin compositions for forming the elastomeric material according to the subject invention are set forth below in Table 1 in parts by weight, unless otherwise indicated.

TABLE 1
Formulation of Resin Composition

| | | | | | | | | | Non- |
|---|---|---|---|---|---|---|---|---|---|
| | First | First | Second | Surfactant | Surfactant | Surfactant | Surfactant | Chain | Reactive |
| | Polyol A | Polyol B | Polyol | A | B | C | D | Extender | Diluent |
| Example 1 | 14.00 | — | 26.00 | 10.00 | — | — | — | — | 50.00 |
| Example 2 | 9.73 | — | 30.54 | — | 2.97 | — | — | 6.36 | 50.40 |
| Example 3 | — | 9.73 | 30.54 | — | 2.97 | — | — | 6.36 | 50.40 |
| Example 4 | 9.73 | — | 30.54 | — | — | — | 2.97 | 6.36 | 50.40 |
| Example 5 | — | 9.50 | 30.00 | — | — | — | 3.00 | 5.00 | 52.50 |
| Example 6 | — | 8.00 | 29.00 | — | — | — | 3.00 | 5.00 | 55.00 |
| Example 7 | 9.73 | — | 30.54 | — | — | — | 9.33 | — | 50.40 |
| Example 8 | — | 8.00 | 29.00 | — | — | — | 8.00 | — | 55.00 |
| Example 9 | — | 10.00 | 30.50 | — | — | — | 7.00 | — | 52.50 |
| Example | — | 9.50 | 30.00 | — | — | 3.00 | — | 5.00 | 52.50 |
| 10 | | | | | | | | | |
| Example | — | 8.00 | 29.00 | — | — | 3.00 | — | 5.00 | 55.00 |
| 11 | | | | | | | | | |
| Example | 9.73 | — | 30.54 | — | — | 9.33 | — | — | 50.40 |
| 12 | | | | | | | | | |
| Example | | 10.00 | 30.50 | — | — | 7.00 | — | — | 52.50 |
| 13 | | | | | | | | | |

The first polyol A is a trimethylolpropane (TMP) initiated propylene oxide polyol having an actual functionality of approximately 2.96, which is commercially available as TP-740 from BASF Corporation. The first polyol B is a glycerin initiated propylene oxide polyol having an actual functionality of approximately 2.99, which is commercially available as GP-730 from BASF Corporation. The second polyol is an ethylene diamine initiated propylene oxide polyol having an actual functionality of approximately 4, which is commercially available as Quadrol from BASF Corporation. The chain extender is PEG and the non-reactive diluent is TXIB.

Surfactant A is ICONOL® NP-6 from BASF Corporation that is composed of a mono-functional nonyl phenol initiator and a polyethylene glycol chain. The hydrophobic group is the alkyl chain of nine carbons bonded to the phenol, which is also known as nonyl phenol and the hydrophilic group is the polyethylene glycol chain. The surfactant A has a hydroxyl number of from 114 to 120 mg KOH/g, an acid value of 5 to 8 mg KOH/g, and an HLB value of about 10.8. Surfactant B is MAPEG® 200 ML, commercially available from BASF Corporation, comprising a polyethylene glycol monolaurate ester, where the hydrophilic component is polyethylene glycol, the hydrophobic group is an alkyl chain of lauric acid and the two groups are linked by an ester functional group. The surfactant B has a hydroxyl number of about 140 mg KOH/g, an acid value of about 5.0 mg KOH/g maximum, and a HLB value of about 9.3. Surfactant C is MAZOL® 159, commercially available from BASF Corporation, containing a mixture of ethoxylated monoglyceryl cocoate containing an average of 7 moles of ethylene oxide per reactive hydroxyl group, a hydroxyl number of about 194 mg KOH/gram, an acid value of about 5.0 mg KOH/g maximum, and a HLB value of about 13. Surfactant D is MAZOL® 80 MGK, commercially available from BASF Corporation, comprising an ethoxylated monodiglyceride which is comprised of a substituted glyceride containing an alkyl chain of 14 to 18 carbons and capped with about 12 moles of ethylene oxide per reactive end group and a hydroxyl number of about 72 mg KOH/gram, an acid value of about 2.0 mg KOH/g maximum, and a HLB value of about 13.5.

The resin compositions were mixed with a polyisocyanate composition to form the elastomeric material as set forth in Table 2.

TABLE 2
Formulation of Elastomeric Material

| | | | Resin | | Cross-link | |
|---|---|---|---|---|---|---|
| | Resin | Isocyanate | Equivalent | Resin | Weight-average | Cross-link |
| | Composition | Composition | Wt. | OH# | Equivalent Wt. | Functionality |
| Example 1 | 100.00 | 58.08 | 230.40 | 243.49 | 125.20 | 3.11 |
| Example 2 | 100.00 | 78.31 | 170.88 | 328.29 | 114.79 | 3.00 |
| Example 3 | 100.00 | 78.26 | 170.99 | 328.10 | 114.80 | 3.00 |
| Example 4 | 100.00 | 77.82 | 171.95 | 326.26 | 114.92 | 3.03 |
| Example 5 | 100.00 | 73.23 | 182.72 | 307.03 | 115.31 | 3.06 |
| Example 6 | 100.00 | 70.58 | 189.59 | 295.91 | 114.93 | 3.06 |
| Example 7 | 100.00 | 62.85 | 212.90 | 263.51 | 121.37 | 3.27 |
| Example 8 | 100.00 | 58.81 | 227.53 | 246.57 | 120.19 | 3.27 |
| Example 9 | 100.00 | 62.48 | 214.16 | 261.95 | 119.95 | 3.28 |
| Example 10 | 100.00 | 74.11 | 180.57 | 310.69 | 115.05 | 3.06 |
| Example 11 | 100.00 | 71.46 | 187.27 | 299.57 | 114.67 | 3.05 |
| Example 12 | 100.00 | 65.57 | 204.07 | 274.91 | 119.79 | 3.23 |
| Example 13 | 100.00 | 65.52 | 207.39 | 270.51 | 118.84 | 3.24 |

The isocyanate composition is a polymeric isocyanate with an approximate percentage free NCO of about 31 and an approximate average functionality of 2.9 and is commercially available as Lupranate® M70R Isocyanate from BASF Corporation.

A statistical model was derived to relate bowling performance as determined through bowling application testing and measured by the total degree of lane hook to the polymer chemical structure. The higher the absolute value of the total angle, the greater the hook potential of the bowling ball. The following equation can be used to calculate the total angle: Equation 1: f(total angle)=−4699.08+10.927(Resin Eq. Wt.)+9.03(Resin OH#)−0.0814(Xlink Eq. Wt.)−1.942(Xlink functionality)+0.375(Resin Eq. Wt.−213.715)²+0.597(Resin OH#−261.297)(Resin Eq. Wt.−213.715)+0.200(Resin OH#−261.297)²

Equation 1 can be used to determine the projected performance of the elastomeric material as a function of the resin hydroxyl number, the cross-link functionality, the resin equivalent weight, and the cross-link weight-average equivalent weight. These values can be calculated for the resin composition using a formulation that is known to those skilled in the art and that is based on the equations given in “How to calculate crosslink structure in coatings” by Bauer, David R.; Journal of Coatings Technology, Volume 60, No. 758, March 1988, pagers 53-66. The resultant values of calculated total angle for Examples 1-13 are listed in Table 3 along with the physical properties of these examples.

The physical properties that were measured include the gel time for the elastomeric material, the Shore D Hardness (ASTM D2240), oil adsorption, and appearance. The Shore D Hardness measures the penetration of a specified indentor into the elastomeric material under specified conditions of force and time.

The oil adsorption is measured by applying a drop of mineral oil, about 0.0180 grams, onto a disk of the elastomeric material. The disk has a diameter of about 75 mm and the surface has an outer skin that has been removed by wet sanding, which would occur in normal use. The amount of time that it takes for the oil to absorb into the surface is measured. The oil is considered absorbed when it is visually gone from the surface. A satisfactory oil adsorption time is less than 30 minutes, an acceptable time is less than 20 minutes, and a good time is less than 15 minutes. It is most preferred that the oil should be absorbed by the elastomeric material as quickly as possible, while still having the desired hardness.

TABLE 3
Properties of the Elastomeric Material

| | Calculated | | | | |
|---|---|---|---|---|---|
| | Total | Gel | | Oil | |
| | Angle | Time | Shore D | Adsorption | Appearance |
| Example 1 | −8.58 | 1′48″ | 68.00 | 18′ | slight phase |
| Example 2 | −9.99 | 1′9″ | 76 | 8′ | slight phase |
| Example 3 | −10.07 | 1′8″ | 76 | 15′ | slight phase |
| Example 4 | −10.93 | 1′6″ | 76 | 16′58″ | slight phase |
| Example 5 | −13.05 | 1′23″ | 76 | 7′ | slight phase |
| Example 6 | −11.38 | 1′21″ | 74 | 4′15″ | slight phase |
| Example 7 | −9.36 | 1′4″ | 72 | 8′ | slight phase |
| Example 8 | −9.09 | 1′17″ | 71-72 | 1′43″ | slight phase |
| Example 9 | −9.30 | 1′32″ | 72 | 3′ | slight phase |
| Example | −13.28 | 1′21″ | 75-76 | 10′-15′ | slight phase |
| 10 | | | | | |
| Example | −11.97 | 1′23″ | 75 | 5′ | slight phase |
| 11 | | | | | |
| Example | −9.26 | 1′1″ | 74 | 8′ | slight phase |
| 12 | | | | | |
| Example | −9.05 | 1′25″ | 73 | 5′ | slight phase |
| 13 | | | | | |

Examples 1-13 each produce the bowling ball having better than acceptable oil adsorption times. Example 1, which had the surfactant A, was slightly too soft, however, the oil adsorption time was still better than acceptable.

Comparing examples 1 and 2, the elastomeric material having the surfactant B of Example 2 produced a better hardness and a faster oil adsorption than the elastomeric material having surfactant A of Example 1. Comparing examples 2 and 3, Example 2 incorporates the first polyol A and Example 3 incorporates the first polyol B. While Example 2 has a faster oil adsorption than Example 3, the hardness is the same. Comparing Examples 2 and 4, Example 2 has the surfactant B and Example 4 has the surfactant D. Example 2 has a faster oil adsorption, however, the hardness is the same as Example 4. However, Example 5 utilizes the surfactant D with the first polyol B and has an faster oil adsorption than Example 2 and the same hardness.

Comparing Example 5 and 6, the amount of the first polyol B has been reduced and the oil adsorption has become significantly faster with only a small reduction in the hardness. Examples 7-9 and 12-13 prepared the elastomeric material without the chain extender and had satisfactory hardness and much faster oil adsorption times. Examples 10-11 varied the amount of the first polyol B and Example 11 provided a faster oil adsorption while only a slight reduction in hardness. By reducing the amount of the first polyol, the elastomeric material had a tendency to absorb oil faster, however, the hardness also slightly decreased.

Examples 1-13 each had an appearance of slight phase. Some of the examples had slightly more or slightly less phase than some of the others. Ultimately, all of the examples could be colored with pigments to provide a distinctive appearance without largely impacting these physical properties.

Obviously, many modifications and variations of the present invention are possible in light of the above teachings. The invention may be practiced otherwise than as specifically described within the scope of the appended claims.

What is claimed is:

1. An elastomeric material comprising:
a resin composition comprising A) a first polyol having an actual functionality of from 2.0 to 7.0 and a hydroxyl number of from 100 to 600 mg KOH/g; B) a second polyol having an actual functionality of from 3.5 to 5.0 and a hydroxyl number of greater than 600 mg KOH/g; and C) a surfactant comprising the reaction product of i) a mono- or a poly-functional initiator, ii) at least one hydrophilic component having a polyether chain of from 4 to 40 carbon atoms and having at least one isocyanate-reactive group, and iii) at least one hydrophobic group having an alkyl chain of from 4 to 50 carbon atoms;
a polyisocyanate composition for reacting with said resin composition to form cross-linkages therewith to define a matrix;
a non-reactive diluent dispersed within said matrix; and
said elastomeric material having a weight-average equivalent weight between said cross-linkages of from 75 to 250 g/mol resulting from the reaction of said polyisocyanate composition and said resin composition.

2. An elastomeric material as set forth in claim 1 wherein said resin composition has a hydroxyl number of from 100 to 500 mg KOH/g.

3. An elastomeric material as set forth in claim 1 wherein said resin composition has an equivalent weight of between 100 and 400.

4. An elastomeric material as set forth in claim 1 having a cross-link functionality of from 2 to 5 cross-linkages per unit mass of said elastomeric material based upon the reaction of said polyisocyanate composition and said resin composition.

5. An elastomeric material as set forth in claim 1 wherein said surfactant has a hydroxyl number of from 60 to 200 mg KOH/g and a hydrophilic/lipophilic balance (HLB) of greater than 6.5.

6. An elastomeric material as set forth in claim 1 wherein said surfactant has an acid value of from 2 to 8 mg KOH/g.

7. An elastomeric material as set forth in claim 1 wherein said surfactant comprises ester linkages bonding said hydrophobic groups to at least one of said initiator and said hydrophilic component.

8. An elastomeric material as set forth in claim 1 wherein said non-reactive diluent is present in an amount of from 35 to 65 parts by weight based on 100 parts by weight of said resin composition.

9. An elastomeric material as set forth in claim 8 wherein said non-reactive diluent comprises 2,2,4-trimethyl-1,3-pentanediol diisobutyrate.

10. An elastomeric material as set forth in claim 1 wherein said hydrophobic group is further defined as a fatty acid ester.

11. An elastomeric material as set forth in claim 10 wherein said fatty acid ester is selected from butanates, hexanates, octanoates, decanoates, laureates, stearates, palmitates, and mixtures thereof.

12. An elastomeric material as set forth in claim 1 wherein said polyether chain comprises ethylene oxide, propylene oxide, butylene oxide, and mixtures thereof.

13. An elastomeric material as set forth in claim 1 wherein said mono-functional initiator is further defined as an aromatic hydrocarbon having hydroxyl groups bonded thereto.

14. An elastomeric material as set forth in claim 1 wherein said poly-functional initiator is selected from diols, triols, tetrols and higher functionality alcohols, amines, and mixtures thereof.

15. An elastomeric material as set forth in claim 14 wherein said triol is selected from glycerin, trimethylolethane, trimethylolpropane, and mixtures thereof.

16. An elastomeric material as set forth in claim 15 wherein said triol-initiated surfactant has an actual functionality of from 0.5 to 3.

17. An elastomeric material as set forth in claim 14 wherein said diol is selected from polyethylene glycol, polypropylene glycol, polybutylene glycol, and mixtures thereof.

18. An elastomeric material as set forth in claim 17 wherein said diol-initiated surfactant has an actual functionality of from 0.5 to 2.

19. An elastomeric material as set forth in claim 14 wherein said tetrol or higher is selected from erythritol, pentaerythritol, dipentaerythritol, dulcitol, threitol, and mixtures thereof.

20. An elastomeric material as set forth in claim 14 wherein said amine is selected from alkanolamines, ethylene diamines, diethylene triamines, and mixtures thereof.

21. An elastomeric material as set forth in claim 1 wherein said poly-functional initiator comprises glycerin.

22. An elastomeric material as set forth in claim 21 wherein said hydrophobic group is selected from butanates, hexanates, octanoates, decanoates, laureates, stearates, palmitates, and mixtures thereof.

23. An elastomeric material as set forth in claim 22 wherein said polyether chain comprises ethylene oxide.

24. An elastomeric material as set forth in claim 23 wherein said ethylene oxide is present in an amount of from 5 to 25 moles per mole of glycerin.

25. An elastomeric material as set forth in claim 1 wherein said first polyol is formed from a polyol initiator selected from trimethylolpropane, polyethylene glycol, polypropylene glycol, glycerin, and mixtures thereof.

26. An elastomeric material as set forth in claim 1 wherein said second polyol is formed from an amine-based initiator.

27. An elastomeric material as set forth in claim 26 wherein said amine-based initiator is further defined as ethylene diamine.

28. An elastomeric material as set forth in claim 1 wherein said first polyol is present in an amount of from 5 to 25 parts by weight based on 100 parts by weight of said resin composition.

29. An elastomeric material as set forth in claim 1 wherein said second polyol is present in an amount from 15 to 45 parts by weight based on 100 parts by weight of said resin composition.

30. An elastomeric material as set forth in claim 1 further comprising a chain extender selected from aliphatic diols, triols, and mixtures thereof and present in an amount of from 0.1 to 10 parts by weight based on 100 parts by weight of said resin composition.

31. An elastomeric material as set forth in claim 1 having a Shore D hardness of at least 72.

32. An elastomeric material as set forth in claim 1 wherein said material is a coverstock for a bowling ball.
